(19) United States
(12) Patent Application Publication
(10) Pub. No.: US 2006/0266480 A1
(43) Pub. Date: Nov. 30, 2006

(54) Coating film transfer tool and cartridge to be used in the tool

(75) Inventor: Yasuo Murakoshi, Ageo-shi (JP)

Correspondence Address: EDWARDS & ANGELL, LLP, P.O. BOX 55874, BOSTON, MA, 02205, US

(73) Assignee: Tombow Pencil Co. Ltd.

(21) Appl. No.: 11/429,756

(22) Filed: May 8, 2006

(30) Foreign Application Priority Data
May 26, 2005 (JP) 2005-154049

(51) Int. Cl. B44C 7/00; B65D 85/02

(52) U.S. Cl. 156/577; 242/588.3; 242/588.6; 156/540

(57) ABSTRACT

A coating film transfer tool has a container which can be opened and is composed of a container body and a cover member. The container can be loaded in exchangeable manner with a cartridge equipped with a feed reel having an unused transfer tape wound thereon. The unused transfer tape is equipped at its free end with a retaining member which is retained on a receiving portion of a take-up reel arranged in the container, thereby to facilitate the take-up of the transfer tape by the take-up reel.

### BACKGROUND OF THE INVENTION

1. Field of the Invention

The present invention relates to a coating film transfer tool for transferring a correcting or paste coating film, and a cartridge for used in the coating film transfer tool.

2. Description of Related Prior Art

In the prior art, there is known a refill type coating film transfer tool, in which an unused transfer tape is loaded in exchangeable manner into a container which can be opened and is composed of a container body and a cover member.

In order to facilitate the exchange of the transfer tape, many cartridge types are used for refill type coating film transfer tools (as referred to in the below-mentioned Patent Publication 1, for example).

Generally speaking, in the conventional cartridges, however, a take-up reel having the unused transfer tape wound thereon and a take-up reel are disposed so that not only the feed reel but also the take-up reel are discarded when the cartridge is discarded after use. Moreover, the feed reel and the take-up reel are coaxially arranged in the coating film transfer tool described in Patent Publication 1, so that the coating film transfer tool becomes considerably thick and raises a problem in that it cannot be thinned.

[Patent Publication 1] JP-A-2001-316031

### SUMMARY OF THE INVENTION

In view of the aforementioned current practice, an object of the present invention is to provide an improved coating film transfer tool for use with a cartridge. Another object of the invention is to provide a coating film transfer tool for use with a cartridge, which enables to exploit resources more efficiently and/or facilitates the take-up of a transfer tape at an exchanging time. Furthermore another object of the invention is to provide a coating film transfer tool for use with a cartridge having a reduced thickness.

In accordance with one aspect of the invention a coating film transfer tool is provided comprising a container which can be opened and includes a container body and a cover member, said container can be loaded in exchangeable manner with a cartridge including a feed reel having an unused transfer tape wound thereon. The improvement is in a retaining member disposed at a free end of the unused transfer tape, and retained on a receiving portion of a take-up reel arranged in the container, whereby the take-up of the transfer tape by the take-up reel is facilitated.

The retaining member according to an embodiment of the invention includes a retaining member of a small column shape attached to the free end of the unused transfer tape at a right angle with respect to the longitudinal direction of the transfer tape, and wherein grooved receiving portions for fitting the retaining member therein are formed in the circumference of the take-up reel at a right angle with respect to the circumferential direction thereof.

In accordance with another embodiment of the invention the retaining member includes a hook-shaped retaining member attached to the free end of the unused transfer tape, and wherein grooved receiving portions for retaining the hook-shaped retaining member therein are formed in the circumference of the take-up reel.

In accordance with another embodiment of the invention the cartridge includes a retaining member holding unit for holding the retaining member at a predetermined position before the cartridge is loaded into the container.

In accordance with another embodiment of the invention the retaining member holding unit includes a transfer tape holding unit disposed in the cartridge for holding the vicinity of the free end of the transfer tape having the retaining member attached thereto.

In accordance with another aspect of the invention a cartridge for use with a coating film transfer tool is provided, said cartridge including a feed reel having an unused transfer tape wound thereon and a retaining member disposed at a free end of the unused transfer tape.

The following advantages are attained by the invention.

A the time of exchanging the transfer tape, the transfer tape can be taken up easily and in reliable manner on the take-up reel merely by loading the cartridge into the container and by retaining the retaining member, which is disposed at the free end of the unused transfer tape wound on the feed reel of the cartridge, on the receiving portion of the take-up reel arranged in the container. Even if the cartridge is discarded, the take-up reel is not discarded but can be used repeatedly thereby to exploit the resources efficiently. At the same time, the feed reel and the take-up reel are not coaxially arranged so that the thickness of the coating film transfer tool can be reduced.

The retaining member does not protrude from the circumference of the take-up reel to raise no trouble in the winding of the transfer tape.

The retaining member and the receiving portions can be retained easily and in reliable manner.

When cartridge is loaded into the container it is possible to hold the retaining member at a predetermined position and to prevent the retaining member effectively from rocking to damage the transfer tape.

It is possible to simply provide a retaining member holding unit, which holds a supporting member in the cartridge before loaded into the container, at a predetermined position and in which the transfer tape is not damaged by the rocking motion of the supporting member.

The accompanying drawings which are incorporated in and constitute part of the present specification, are included to illustrate and provide for a further understanding of the invention.

### BRIEF DESCRIPTION OF THE DRAWINGS

FIG. 1 is a perspective view showing a first embodiment of a coating film transfer tool;

FIG. 2 is an exploded perspective view of the coating film transfer tool shown in FIG. 1;

FIG. 3 is an exploded perspective view of a cartridge in the coating film transfer tool shown in FIG. 1;

FIG. 4 is a top plan view of the coating film transfer tool shown in FIG. 1 and of the state, in which a cover member is removed and in which a transfer head member is contained in a container body;

FIG. 5 is a section taken along line V-V of FIG. 4, but shows the state, in which the container body is covered with the cover member;

FIG. 6 is a top plan view of FIG. 4 of the state, in which the transfer head member has its front end protruded from the front end opening of a container;

FIG. 7 is a section taken along line VII-VII of FIG. 6, but shows the state, in which the container body is covered with the cover member;

FIG. 8 is an enlarged perspective view of an essential portion, and shows the assembled state of the transfer head member in head mounting holes and the state, in which the transfer head member is contained in the container;

FIG. 9 is an enlarged perspective view of an essential portion, and shows the assembled state of the transfer head member in the head mounting holes and the state, in which the transfer head member has its front end protruded from the front end opening; and

FIG. 10 shows a second embodiment of the coating film transfer tool of the invention and corresponds to FIG. 4.

### DETAILED DESCRIPTION OF THE PREFERRED EMBODIMENTS

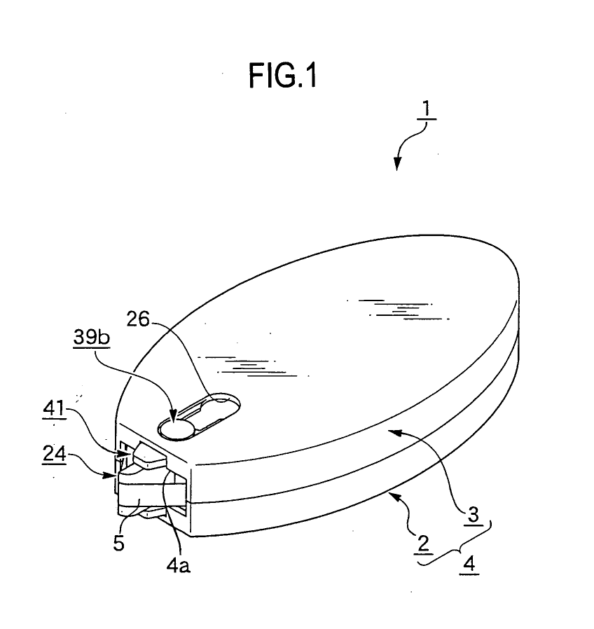

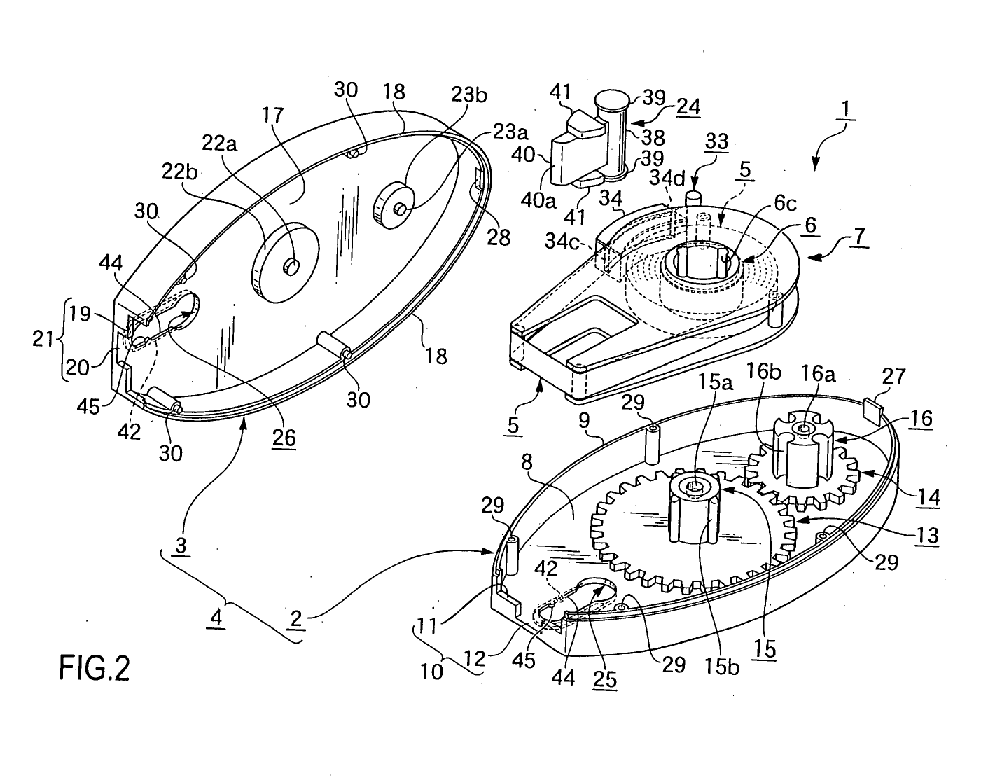

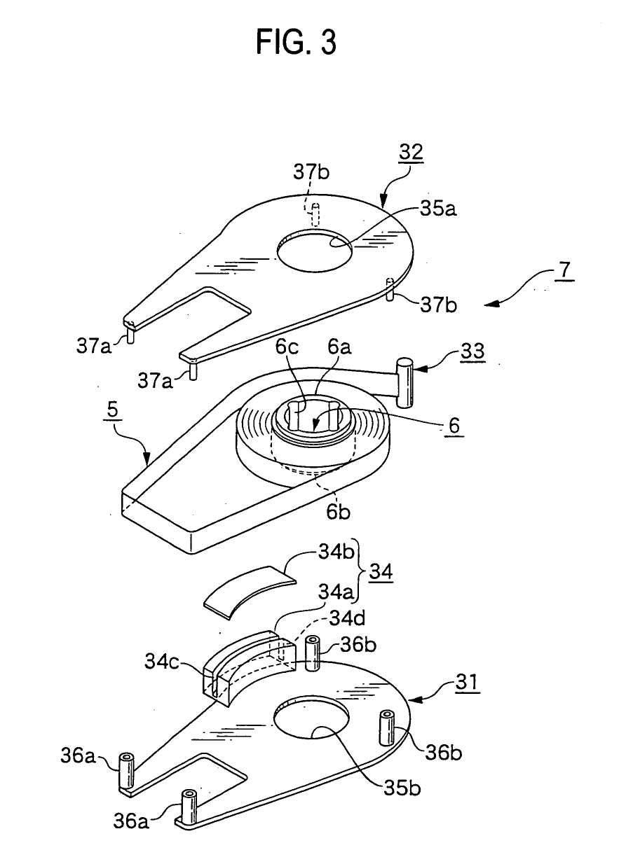

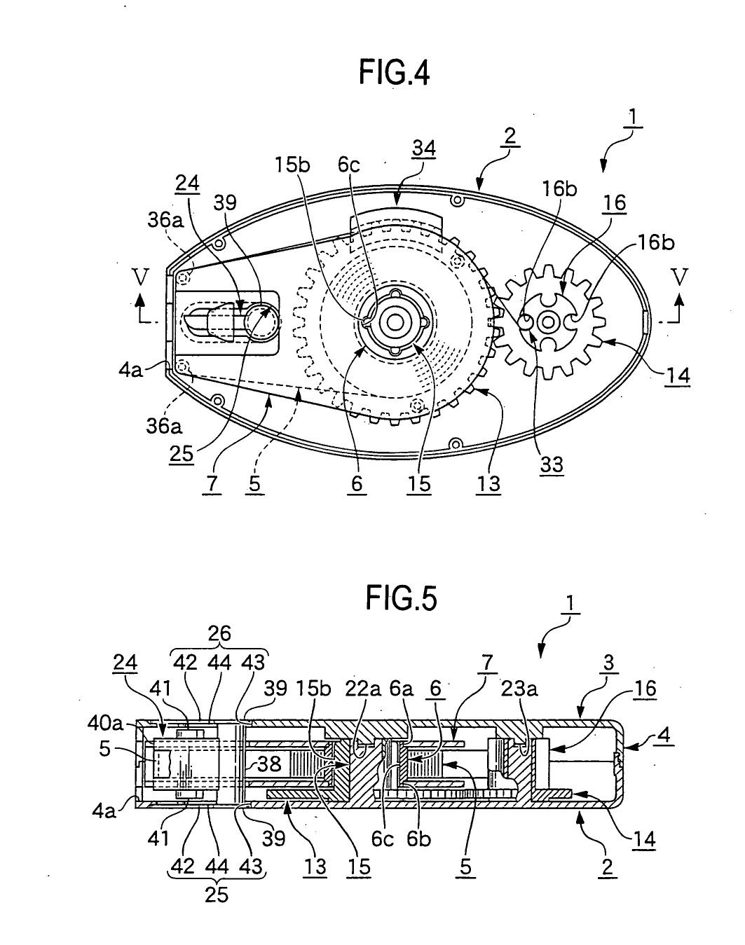

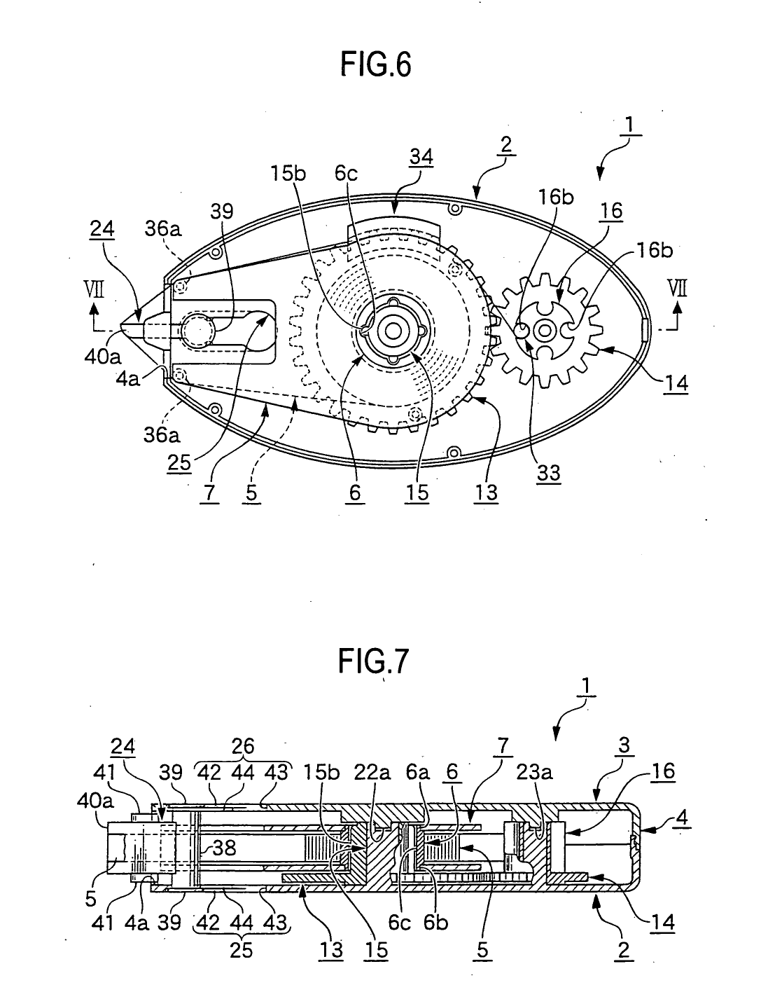

FIG. 1 is a perspective view showing a first embodiment of a coating film transfer tool; FIG. 2 is an exploded perspective view of the coating film transfer tool shown in FIG. 1; FIG. 3 is an exploded perspective view of a cartridge in the coating film transfer tool shown in FIG. 1; FIG. 4 is a top plan view of the coating film transfer tool shown in FIG. 1 and of the state, in which a cover member is removed and in which a transfer head member is contained in a container body; FIG. 5 is a section taken along line V-V of FIG. 4 (but shows the state, in which the container body is covered with the cover member); FIG. 6 is a top plan view of FIG. 4 of the state, in which the transfer head member has its front end protruded from the front end opening of a container; and FIG. 7 is a section taken along line VII-VII of FIG. 6 (but shows the state, in which the container body is covered with the cover member).

A coating film transfer tool (1) of the invention is constituted by loading a container (4) which can be opened and is composed of a container body (2) and a cover member (3), in exchangeable manner with a cartridge (7) including a feed reel (6) having an unused transfer tape (5) fitted therein.

The container body (2) is constituted to include a bottom plate (8) shaped such that a general ellipse elongated in the longitudinal direction in a top plan view is cut straight at its front end, and a side wall (9) erected upward from the peripheral edge of the bottom plate (8). The side wall (9) is cut at its front end to have a cut-away portion (10). This cut-away portion (10) is composed, in its front view, of a first cut-away portion (11) cut away in an upward C-shape, and a second cut-away portion (12) cut away in a slightly smaller upward C-shape at the center surrounded by either side of the first cut-away portion (11).

In the container body (2), there are arranged a feed gear (13) and a take-up gear (14), which are associated to mesh with each other and to rotate. A feed reel bearing shaft (15) and a take-up reel (16) are so coaxially mounted on the feed gear (13) and the take-up gear (14), respectively, as to integrally rotate.

Between the feed gear (13) and the bottom plate (8) of the container body (2), there is interposed the well-known rotational direction regulating means (although not shown) for regulating the rotation of the feed gear (13) in one direction.

On the other hand, the cover member (3) is constituted to include the bottom plate (8) of the container body (2), a top plate (17) of the same shape, a side wall (18) erected downward from the peripheral edge of the top plate (17). The side wall (18) is equipped at its front end with a cut-away portion (21) composed of a first cut-away portion (19) and a second cut-away portion (20) in the same manner as in the side wall (9) of the container body (2). The lower face of the top plate (17) is equipped, at positions corresponding to the feed reel bearing shaft (15) and the take-up reel (16) in the container body (2), with pins (22a) and (23a), which can be fitted in the respective axial holes (15a) and (16a) of the feed reel bearing shaft (15) and the take-up reel (16), and pedestals (22b) and (23b) for the pins (22a) and (23a), respectively.

In the front portions of the bottom plate (8) of the container body (2) and the top plate (17) of the cover member (3), there are formed head mounting holes (25) and (26) for mounting a transfer head member (24).

The shapes of the head mounting holes (25) and (26) and the mounting mode of the transfer head member (24) in those head mounting holes (25) and (26) will be described in detail.

The side wall (9) at the rear end portion of the container body (2) is equipped with an engaging pawl (27) which protrudes upward from the upper edge. The side wall (18) of the cover member (3) is equipped, at a position corresponding to that engaging groove (27), with an engaging recess (28).

The inner side face of the side wall (9) of the container body (2) is equipped at its four portions with vertically cylindrical engaging portions (29). The inner side face of the side wall (18) of the cover member (3) is equipped, at the positions corresponding to the cylindrical engaging portions (29), with downward retaining pins (30).

As shown in FIG. 3, the cartridge (7) is constituted to include: a pair of lower and upper cartridge plate members (31) and (32) having a general horseshoe shape; the feed reel (6), on which the unused transfer tape (5) is wound; a retaining member (33) attached to the free end of the transfer tape (5); and a transfer tape holding unit (34).

The feed reel (6) is radially reduced (as referred to FIG. 5) at its upper and lower ends (6a) and (6b). In the rear portions of the lower and upper cartridge plate members (31) and (32), there are formed fitting holes (35a) and (35b) for rotatably fitting therein the radially reduced lower and upper ends (6b) and (6a) of the feed reel (6).

The inner periphery of the feed reel (6) is equipped at its four equal interval portions with vertical grooved engaging portions (6c) of a semi-column shape (as referred to FIG. 4).

As shown in FIG. 3, the retaining member (33) of the small column shape is attached to the free end of the transfer tape (5) at a right angle with respect to the longitudinal direction of the transfer tape (5).

The transfer tape holding unit (34) is composed of a tape holding unit body (34a), in which a groove (34c) for guiding the transfer tape (5) therethrough is formed in a square bar slightly curved along the peripheral edges of the cartridge plate members (31) and (32), and a cover plate (34b). On the upper face of the lower cartridge plate member (31), there are erected upward cylindrical engaging portions (36a) and (36b) individually on the right and left sides of the front and rear ends. Downward engaging pins (37a) and (37b) are erected downward at such positions on the lower face of the upper cartridge plate member (32) as correspond to the cylindrical engaging portions (36a) and (36b).

The cartridge (7) is assembled by the following procedure.

First of all, the tape holding unit body (34a) is fixed by means of an adhesive to a one-side peripheral edge of the rear portion of the lower cartridge plate member (31).

Next, the radially reduced lower end (6b) of the feed reel (6), on which the transfer tape (5) is wound, is rotatably fitted in the fitting hole (35b) of the lower cartridge plate member (31).

Next, the transfer tape (5) is threaded from the outside (as referred to FIG. 4) on the two cylindrical engaging portions (36a) and (36a) erected from the front portion of the lower cartridge plate member (31). After this, the vicinity of the free end portion of the transfer tape (5) is so inserted into the groove (34c) of the tape holding unit body (34a) that the retaining member (33) of the small cylinder shape attached to the free end portion of the transfer tape (5) is brought into abutment against the rear end face (34d) of the tape holding unit body (34a).

Next, the cover plate (34b) is fixed in advance by means of an adhesive to such a position in the upper cartridge plate member (32) as corresponds to the tape holding unit body (34a), and the upper cartridge plate member (32) having the cover plate (34b) fixed thereto is integrated downward with the lower cartridge plate member (31).

For this integration, the radially reduced upper end (6a) of the feed reel (6) is rotatably fitted in the fitting hole (35a) of the upper cartridge plate member (32), and the retaining pins (37a) and (37b) erected from the upper cartridge plate member (32) are fitted in the cylindrical engaging portions (36a) and (36b) erected from the lower cartridge plate member (31).

Thus, the cartridge (7) is obtained, as shown in FIG. 2.

The vicinity of the free end of the transfer tape (5) having the retaining member (33) attached thereto is held by the transfer tape holding unit (34), so that the transfer tape holding unit (34) also functions as a retaining member holding unit for holding the retaining member (33) in the vicinity of the rear end face (34d) of the transfer tape holding unit (34).

In order that the cartridge (7) is loaded into the container (4) to assemble the coating film transfer tool (1), the feed reel (6) in the cartridge (7) is fitted downward on the feed reel bearing shaft (15) arranged in the container body (2) thereby to load the cartridge (7) into the container body (2). At this time, retaining portions (15b) of a semi-column shape, which are vertically disposed on the outer circumference of the feed reel bearing shaft (15), are retained (as referred to FIG. 4) in grooved engaging portions (6c) formed in the inner circumference of the feed reel (6), so that the feed reel (6) and the feed reel bearing shaft (15) may rotate integrally with each other.

Here, the slip mechanism (although not shown) is interposed between the feed reel bearing shaft (15) and the feed gear (13).

Next, the retaining member (33) of the small column shape attached to the free end of the transfer tape (5), as shown in FIG. 4, is fitted in one of grooved receiving portions (16b), which are so formed in the outer circumference of the take-up reel (16) arranged in the container body (2) as are vertically directed to have a narrowed opening width.

Next, the transfer head member (24) is assembled with the head mounting holes (25) and (26) of the container body (2) and the cover member (3), and the container body (2) is crowned with the cover member (3), so that the coating film transfer tool (1) is assembled by fitting the retaining pins (30) in the cover member (3) in the cylindrical engaging portions (29) of the container body (2).

At this time, the individual pins (22a) and (23a) of the cover member (3) are so fitted in the axial holes (15a) and (16a) of the feed reel bearing shaft (15) and the take-up reel (16) arranged in the container body (2) that the feed reel bearing shaft (15) and the take-up reel (16) can freely rotate.

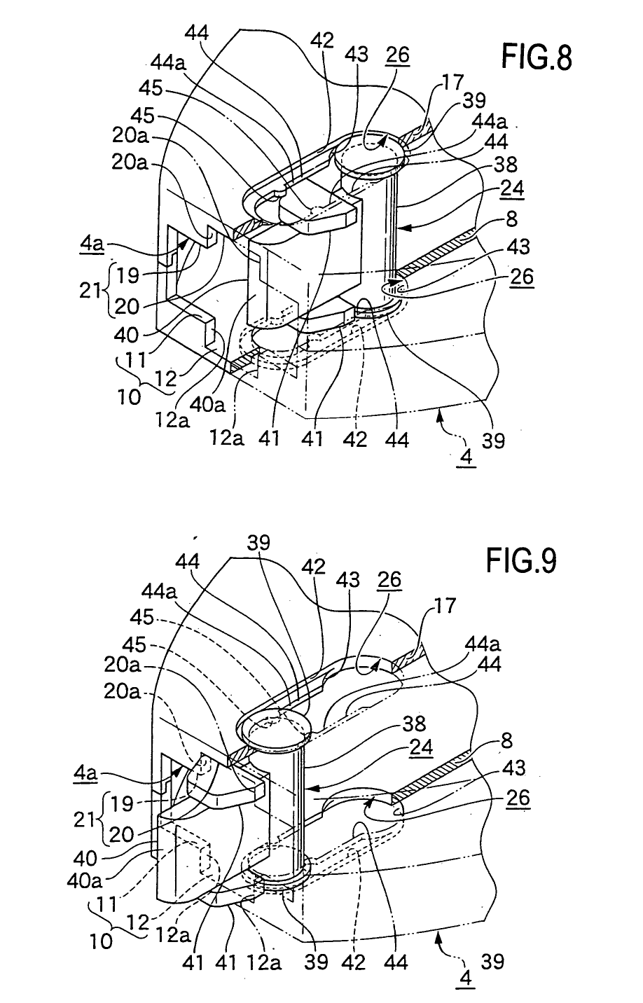

FIG. 8 and FIG. 9 are enlarged perspective views of an essential portion, and show the assembled state of the transfer head member (24) in the head mounting holes (25), (26). FIG. 8 shows the state, in which the transfer head member (24) is contained in the container (4), and FIG. 9 shows the state, in which the front end (40a) of the transfer head member (24) protrudes from the front end opening (4a) of the container (4).

As shown in FIG. 2, FIG. 8 and FIG. 9, the transfer head member (24) is constituted to include: column shaped operation buttons (39) and (39) disposed at the upper and lower ends of the column-shaped operation lever (38) and made to have a larger diameter than that of the operation lever (38); a head portion (40) of a vertical plate shape having the front end (40a) of a knife edge and directed forward on the front face of the operation lever (38); and guide plates (41) and (41) of a home base shape for the transfer tape (5) disposed at the longitudinal center on the upper and lower faces of the head portion (40).

The bottom plate (8) of the container body (2) and the head mounting holes (25) and (26) in the top plate (17) of the cover member (3) are so shaped as are shown in FIG. 8 and FIG. 9.

In the outer side faces of the bottom plate (8) and the top plate (17), there are formed longitudinal grooves (42) and (42), which have a depth about one half as large as the thickness of the bottom plate (8) and the top plate (17) and which have semi-arcuate front and rear peripheral edges of a radius slightly larger than that of the operation buttons (39). At the rear ends of those grooves (42) and (42), there are formed round holes (43) and (43), which are sized to insert the operation buttons (39) thereinto.

In front of the round holes (43), there are formed longitudinal slits (44) and (44), which communicate with the round holes (43) and through which the operation lever (38) of the transfer head member (24) can slide. The right and left side edges (44a) and (44a) in those slots (44) are equipped at their longitudinal centers with retaining small projections (45) and (45), which are directed inward of the slots (44).

The head mounting holes (25) and (26) are formed to include the grooves (42), the round holes (43), the slots (44) and the retaining small projections (45).

The transfer head member (24) is assembled in the head mounting holes (25) and (26) in the following procedure.

As shown in FIG. 8, the transfer head member (24) is arranged in the container body (2) by inserting it from the inside of the container body (2) and by inserting the lower operation button (39) of the transfer head member (24) into the round hole (43) of the container body (2).

Next, the container body (2) is crowned with the cover member (3), and the upper operation button (39) of the transfer head member (24) is inserted into the round hole (43) of the cover member (3) (as referred to FIG. 5).

Next, the upper and lower operation buttons (39) and (39) are pinched by the fingers of a hand to slide the operation lever (38) of the transfer head member (24) forward in the slots (44) and (44) of the cover member (3) and the container body (2), as shown in FIG. 9, so that the front end (40a) of the transfer head member (24) may protrude from the front end opening (4a) of the container (4), which is formed by the two cut-away portions (10) and (21) in the front ends of the container body (2) and the cover member (3) (as referred to FIG. 6 and FIG. 7).

In this state, the right and left side edges (44a) and (44a) of the slots (44) in the cover member (3) and the container body (2) are vertically clamped by the operation buttons (39) and (39) and the guide plates (41) and (41). At the same time, the guide plates (41) and (41) come into abutment against the right and left edges (20a) and (12a) of the second cut-away portions (20) and (12) in the front end opening (4a) of the container (4) thereby to prevent the rocking motion of the head portion (40).

When the coating film transfer tool (1) is to be used, the coating film applied to the transfer tape (5) is transferred by turning the coating film transfer tool (1) clockwise by 90 degrees, as shown in FIG. 9, by pushing the lower face of the front end of the knife edge in the head portion (40) onto a paper surface or the like, and by retracting the coating film transfer tool (1).

Since the rear face of the operation lever (38) of the transfer head member (24) is retained by the retaining small projections (45) and (45) in the slots (44), the head portion (40) is prevented from moving backward while the coating film transfer tool (1) is being used.

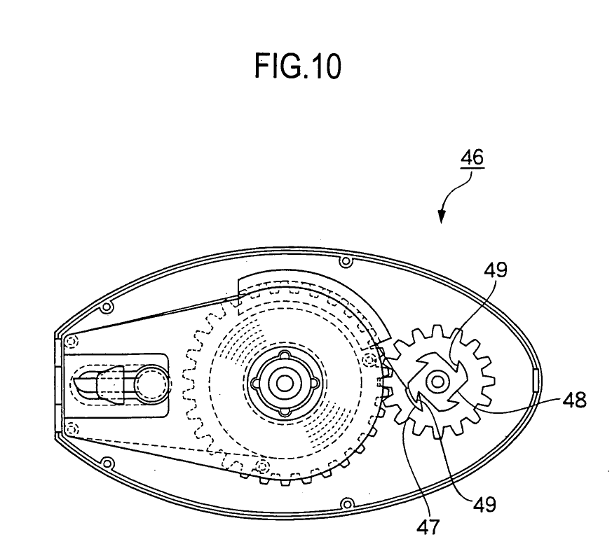

FIG. 10 shows a second embodiment of a coating film transfer tool (46) of the invention, and corresponds to FIG. 4.

What the coating film transfer tool (46) is different from the aforementioned coating film transfer tool (1) resides in that a hook-shaped retaining tool (47) is used as the retaining member in place of the retaining member (33) of the small column shape, and in that a take-up reel (48) is equipped in its circumference with recessed receiving portions (49), with which the hook-shaped retaining tool (47) can engage.

The retaining points are similar to those of the first embodiment so that their description is omitted.

By means of the coating film transfer tool (46) of the second embodiment can achieve advantages can be achieved similar to those of the coating film transfer tool (1) of the first embodiment.

The above description of a preferred embodiment has been given by way of example. From the disclosure given, those skilled in the art will not only understand the present invention and the attendant advantages, but will also find apparent various changes and modifications to the structures disclosed. It is sought, therefore, to cover all such changes and modifications as fall within the spirit and scope of the invention, as defined by the appended claims, and equivalents thereof.

What is claimed is:

1. A coating film transfer tool comprising a container adapted to be opened and including a container body and a cover member, said container can be loaded in exchangeable manner with a cartridge, said cartridge including a feed reel having an unused transfer tape and a retaining member disposed at a free end of the unused transfer tape and retained on a receiving portion of a take-up reel arranged in the container, whereby the take-up of the transfer tape by the take-up reel is facilitated.

2. A coating film transfer tool according to claim 1, wherein the retaining member includes a retaining member of a small column shape attached to the free end of the unused transfer tape at a right angle with respect to the longitudinal direction of the transfer tape, and wherein grooved receiving portions for fitting the retaining member therein are formed in the circumference of the take-up reel at a right angle with respect to the circumferential direction thereof.

3. A coating film transfer tool according to claim 1, wherein the retaining member includes a hook-shaped retaining member attached to the free end of the unused transfer tape, and wherein grooved receiving portions for retaining the hook-shaped retaining member therein are formed in the circumference of the take-up reel.

4. A coating film transfer tool according to claim 1, wherein the cartridge includes a retaining member holding unit for holding the retaining member at a predetermined position before the cartridge is loaded into the container.

5. A coating film transfer tool according to claim 4, wherein the retaining member holding unit includes a transfer tape holding unit disposed in the cartridge for holding the vicinity of the free end of the transfer tape having the retaining member attached thereto.

6. A cartridge for use with a coating film transfer tool including a feed reel having an unused transfer tape wound thereon and a retaining member disposed at a free end of the unused transfer tape.

7. A cartridge according to claim 6, and further including a transfer tape holding unit for holding the vicinity of the free end of the transfer tape having the retaining member attached thereto.
